(19) United States
(12) Patent Application Publication
(10) Pub. No.: US 2012/0270331 A1
(43) Pub. Date: Oct. 25, 2012

(54) MICROFLUIDIC SYSTEM AND METHOD FOR AUTOMATED PROCESSING OF PARTICLES FROM BIOLOGICAL FLUID

(76) Inventors: Achal Singh Achrol, Menlo Park, CA (US); Palaniappan Sethu, Louisville, KY (US); Richard S. Gaster, Mountain View, CA (US)

(21) Appl. No.: 13/452,760

(22) Filed: Apr. 20, 2012

Related U.S. Application Data
(60) Provisional application No. 61/477,482, filed on Apr. 20, 2011.

(51) Int. Cl. G01N 1/18; B01L 3/00

(52) U.S. Cl. 436/177; 422/502

(57) ABSTRACT

A microfluidic system for automatically depleting particles not of interest from a biological sample, comprising: a sampling module configured to receive the sample; and one or more microfluidic protein and nucleic acid depletion modules fluidically coupled to the sampling module and comprising binding agents configured to selectively bind to abundant plasma proteins or nucleic acids. A method for automatically depleting particles not of interest from a sample, comprising: receiving the sample; subjecting the sample to a force that separates at least a portion of the particles not of interest from the sample, thereby isolating at least a portion of the target component; passing the isolated target copmonent into a chamber; circulating the isolated target component in the chamber; and selectively capturing proteins or nucleic acids with binding agents within the chamber.

### CROSS-REFERENCE TO RELATED APPLICATIONS

This application claims the benefit of U.S. Provisional Application Ser. No. 61/411,482, filed 20 Apr. 2011, which is incorporated in its entirety by this reference.

### TECHNICAL FIELD

This invention relates generally to biological tissue analysis in the medical diagnostics and biological research fields, and more specifically to an improved microfluidic system for automated processing of particles from biological fluid.

### BACKGROUND

The identification of new biological markers (biomarkers) in biological tissue analysis is an increasingly essential element of predictive, preventive and personalized medicine as well as in biological tissue research. The fields of medical diagnostics and biological tissue research both depend heavily on the development of promising new biomarkers to help accelerate the delivery of new technologies, medicines and therapies for prevention, early detection, diagnosis and treatment of disease. Biological fluids, including but not limited to blood, urine, saliva and cerebral spinal fluid, are readily accessible for analysis, and various particles of interest in biological fluids can serve as important biomarkers in the fields of medical diagnostics and biological tissue analysis.

Particles of interest as biomarkers in biological fluids include but are not limited to cells, proteins, peptides and nucleic acids. For example, plasma, a component of blood, contains a very high concentration of such proteins and nucleic acids, including diagnostically relevant plasma proteins and RNA transcripts. Diagnostically relevant plasma proteins and other biomarkers are, however, typically in low abundance relative to other proteins such as Human Serum Albumin (HAS), which constitutes over half of all plasma proteins. Analysis of diagnostically relevant plasma proteins represents a tremendous analytical challenge, since such analysis almost always requires depletion of high abundance proteins such as HAS and immunoglobulins (IgG), which by themselves make up approximately 80% of the total proteins in plasma, and serve to decrease the efficacy of various assays by interfering with the detection of less abundant proteins and other particles. Multiple studies have demonstrated improved efficacy and resolution of various assays, with reduced noise and increased sensitivity, when the sample is pre-processed to deplete HAS and IgG.

Current technologies used to deplete HAS and IgG include approaches that rely on physiochemical approaches to fractionate the sample such as alcohol preparation, ultracentrifugation, salting in/salting out, as well as extraction through chromatography columns, extraction through 2D gel electrophoresis, and immuno-affinity columns that contain covalently attached antibodies specific to abundant plasma proteins for selective capture of plasma proteins. However, these current technologies have drawbacks. Major issues include variability in sample collection and handling that introduce handling artifacts, lack of standardized protocols and instrumentation, and extended processing time which prevents accurate analysis of the sample at the time of collection, resulting in time-dependent changes in the sample. Depletion of high abundance proteins via gel electrophoresis or chromatography also carries the risk of the “sponge effect”, in which small proteins and peptides bind to larger carriers. Furthermore, these current technologies have limited efficiency. Thus, a more efficient, thorough, and automated system and method of depleting high abundance proteins from a sample is still needed in order to obtain accurate analyses of diagnostically relevant plasma proteins.

Gene expression profiling of RNA extracted from peripheral blood or other biological fluids and tissues represents another promising method to identify biomarkers and to examine disease states and investigate immune responses. However, similar to plasma proteins, the relatively high proportion of globin messenger RNA transcripts present in total RNA extracted from whole blood can reduce the efficacy of microarray assays by interfering with the detection of less abundant gene transcripts. Current methods that attempt to pre-process the sample to selectively bind to and remove globin messenger RNA, and other highly abundant structural RNA transcripts that do not serve as biomarkers of interest, typically also suffer from problems of introducing handling artifacts, lack of standardized protocols and instrumentation, and extended processing times which prevent accurate analysis of the sample at the time of collection resulting in time-dependent changes in the sample.

Thus, there is a need in the medical diagnostics and biological tissue analysis fields to create an improved system and method for automated collection and processing of relevant particles of interest, and depletion of irrelevant particles not of interest, from blood or other biological fluid samples, including but not limited to urine, saliva, and cerebrospinal fluid (CSF), cell lysates, and cell culture media. This invention provides such an improved system and method.

### BRIEF DESCRIPTION OF THE FIGURES

FIG. 1 is a schematic representation of the microfluidic particle isolation system of a preferred embodiment;

FIGS. 2A and 2B are schematic representations of variations of the sampling module of the system of a preferred embodiment;

FIG. 3 is a schematic representation of the particle depletion module of the system of a preferred embodiment;

FIG. 4 is a schematic representation of an example of increasing sedimentation rate of selected particles in the particle depletion module of the system of a preferred embodiment;

FIG. 5 is a schematic representation of binding a selected particle with tagging agents for use in another variation of the particle depletion module utilizing a magnetic field in the system of a preferred embodiment;

FIGS. 6-12 are schematic representations of variations of the particle depletion module of a preferred embodiment; and

FIG. 13 is a flowchart of the method for isolating particles of interest from biological fluids of a preferred embodiment.

### DESCRIPTION OF THE PREFERRED EMBODIMENTS

The following description of preferred embodiments of the invention is not intended to limit the invention to these preferred embodiments, but rather to enable any person skilled in the art to make and use this invention.

System for Automated Processing of Particles from Biological Fluid

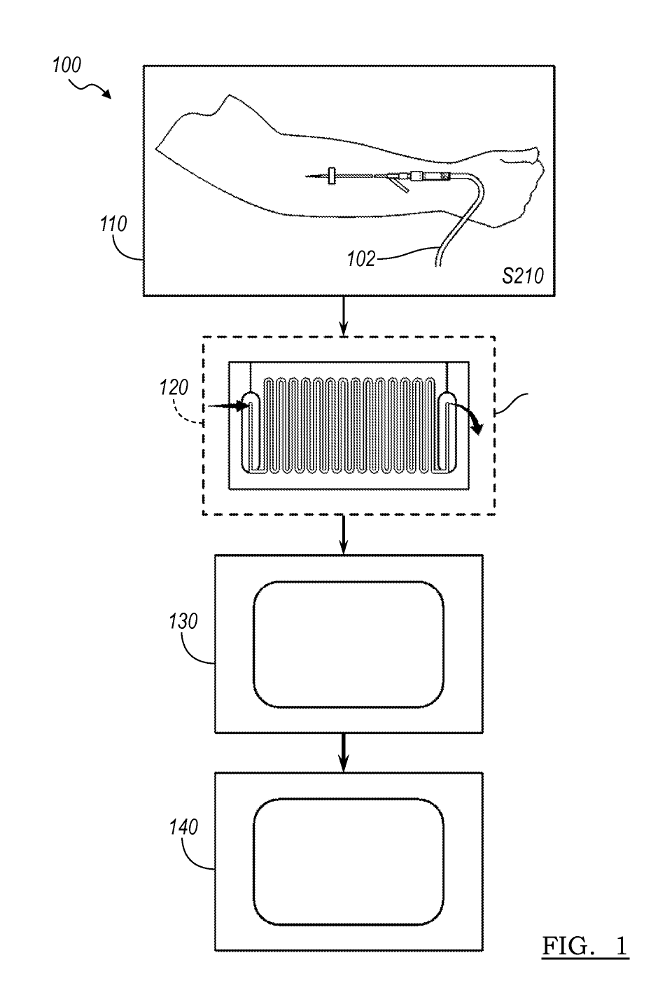

As shown in FIG. 1, the system 100 of a preferred embodiment includes a sampling module 110 configured to fluidically couple to a cannula coupled to the patient and to receive the sample 102 of biological fluid from the patient at a point-of-care of the patient; a first microfluidic particle depletion module 130 fluidically coupled to the sampling module 110 to receive the sample 102 and configured to separate at least a portion of particles not of interest from the sample 102, thereby providing a depleted sample; and a second microfluidic particle depletion module 140, fluidically coupled to the first particle depletion module 130 to receive the depleted sample 102 and configured to separate particles of interest from other particles not of interest in the sample 102. The preferred system 100 preferably depletes the sample, in an automated manner, of particles not of interest in order to isolate or produce a depleted sample substantially including only particles of interest. In a preferred embodiment, the particles not of interest can be abundant within a sample and overwhelm less populous particles of interest. For example, the system 100 can be configured to deplete the received sample of cellular contaminants or abundant proteins such as albumin, IgG, IgA, IgM, fibrinogen, haptoglobin, alpha 1 antitrypsin, Apo A I, Apo A II, and A2 macroglobulin.

In particular the system 100 preferably facilitates isolation of diagnostically relevant particles such as proteins, peptides, and nucleic acids that are present in blood or other relevant fluid sample types (e.g., urine, saliva, cerebrospinal fluid (CSF), serum, plasma, tears, cell lysates, and cell culture media) by sorting particular particles with particular expression characteristics with the use of agents selectively bound to particular particles through antibodies or other specific recognition agents (e.g., proteins, ligands, receptors, enzymes, peptides, diabodies, fab fragments, aptamers, synthetic substances, peptibodies, nucleic acids, oligonucleotides). In alternative embodiments, the system 100 may be used to isolate nucleic acids using agents selectively bound to particular nucleic acids, including but not limited to DNA, RNA, or microRNA, such as for isolating DNA from specific cell types or isolating RNA for cell type-specific gene expression analysis. However, the system 100 can additionally or alternatively be used to isolate any suitable particles of interest by depletion of any suitable particles not of interest in the sample.

The preferred system 100 is preferably used at the point-of-care for clinical purposes including prognosis, diagnosis, and/or patient monitoring, but can additionally or alternatively be performed in a suitable research and/or laboratory environment, such as to enable clinician-scientists to process samples at the point-of-care in clinical trials and research. In some embodiments in which at least some of the sample 102 is returned to the patient for recirculation in the body of the patient, the system 100 can selectively isolate and remove specific proteins and/or other particles from the sample 102 of biological fluid, while returning the remaining processed fluid back to the patient. Furthermore, in some embodiments of the system 100, the system 100 can add a therapeutic agent to the returning fluid to help treat the patient by, for example, controlling administration of therapeutic agents on the basis of detected levels of particles present in the biological fluid of the patient. However, the system 100 can additionally or alternatively discard some or all of the sample.

The sampling module 110 functions to receive a sample 102 of biological fluid from the patient for analytical purposes. As shown in FIG. 1, the sampling module 110 preferably includes or is configured to couple to a cannula, and more preferably a catheter coupled to the patient that obtains the sample 102. As one example, the catheter may obtain a blood sample from the patient through an arterial line, an intravenous line, a peripherally inserted central catheter (PICC), a central line, and/or an in-dwelling catheter. As another example, the catheter may obtain cerebrospinal fluid sample through an external ventricular drain (EVD) or a lumbar drain. As another example, a Foley catheter or a suprapubic catheter may be used to obtain a urine sample. However, the cannula may alternatively be any suitable kind of device for obtaining a sample 102 of biological fluid. The sampling module 110 preferably at least partially mounts on or near the patient, to enable the system 100 to perform particle isolation more immediately after the sample 102 is taken from the patient, such as for diagnostic or other analytical purposes. For example, the system 100 may be appropriate in cases such as when the sample 102 is a fluid that degenerates or otherwise changes relatively quickly and must be analyzed soon after being obtained to achieve accurate results; when the sample is difficult to safely store before particle isolation and/or analysis can be performed; or any other suitable situation that requires swift and immediate particle isolation and/or analysis. The sample 102 may be blood, cerebrospinal fluid, urine, and/or any suitable biological fluid and preferably contains particles of multiple sample particle types. For example, a blood sample typically includes more common particle types like erythrocytes and leukocytes, rare particle types like proteins and nucleic acids, and may or may not include rare potential particle types of interest like circulating tumor cells.

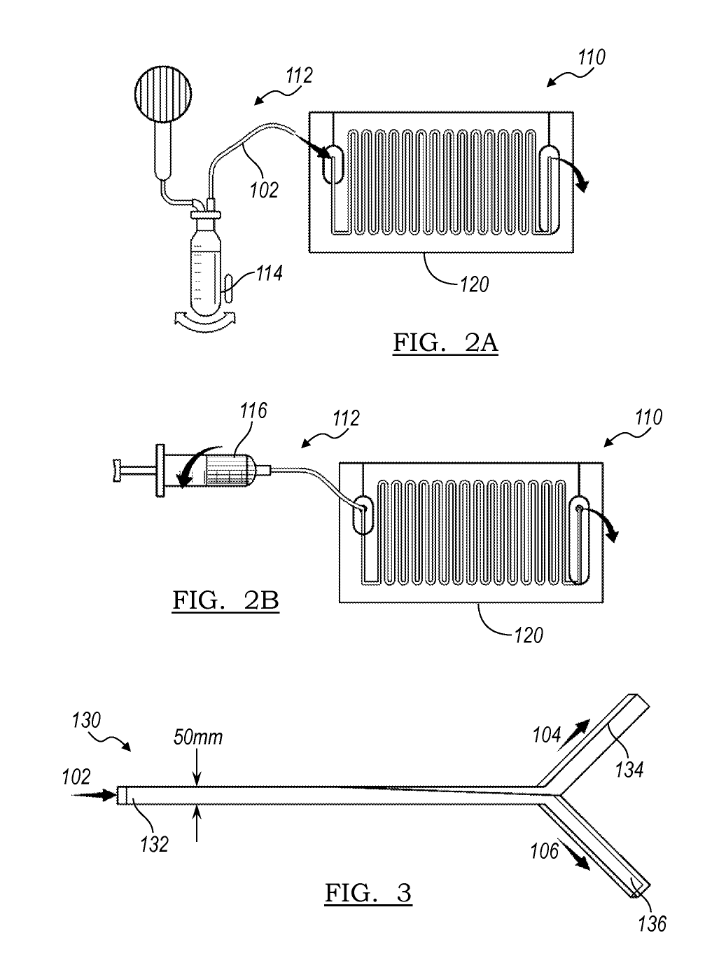

As shown in FIG. 2, the sampling module 110 may further function to prepare the sample 102 by maintaining a uniform distribution of particles throughout the sample. For example, cell sedimentation, which typically occurs at rates on the order of 1 μm/sec, is undesirable because sedimentation leads to a non-uniform distribution of cells in the sample, and in certain applications the devices of the system 100 ideally handle samples with uniform cell distribution such that a sample input of a certain volume contains a fixed and known number of cells. The sampling module no preferably includes a perturbing mechanism 112 that prepares the sample 102 by moving in a manner that reduces sedimentation of the particles in the sample 102, and a sample transfer device that drives the sample into the perturbing mechanism. The perturbing mechanism 112 of the sample delivery module may be a rocker 114 (FIG. 2A) that continuously and gently rocks back and forth to agitate the sample 102 and prevent sedimentation. Alternatively, the perturbing mechanism 112 may be a rotating mechanism 116 (FIG. 2B) such as a horizontally oriented syringe pump that continuously rotates like a cement truck to prevent sedimentation. The perturbing mechanism 112 may, however, be any suitable mechanism that prevents or reduces sedimentation in any suitable manner.

The sample transfer device of the sampling module no preferably functions to drive the sample 102 into the perturbing mechanism. The sample transfer device is preferably a tubing or a channel through which fluid may flow driven by a pressure source such as a dialysis roller pump, syringe pump or balloon, or vacuum tubing, but may alternatively be any suitable device or method that aids delivery of the sample 102 from the cannula to the perturbing mechanism. In some embodiments, the sampling module no additionally and/or alternatively functions to transport and prepare tagging agents such as immuno-modified beads in a solution, to maintain a solution of uniformly distributed tagging agents. The perturbing mechanism that prepares the tagging agents is preferably similar to the perturbing mechanism of the preferred embodiment that prepares the sample 102.

The preferred system 100 can include one or more microfluidic tagging conduits 120 that distinguish multiple particle types in the sample 102 from one another using tagging agents that selectively bind to particles, such as to distinguish targeted particles of interest from non-targeted particles that are not of interest. The tagging agents preferably include or are functionalized with antibodies that are specific to at least one selected particle type. For example, the tagging agents can be magnetic beads or other suitable tagging agents. The microfluidic tagging conduit 120 and/or tagging agents are preferably similar to that described in U.S. Patent Application 2011/0020459 entitled “Microfluidic method and system for isolating particles from biological fluid”, which is incorporated in its entirety by this reference. However, the microfluidic tagging conduit 120 and/or tagging agents can alternatively be any suitable kind of tagging conduit.

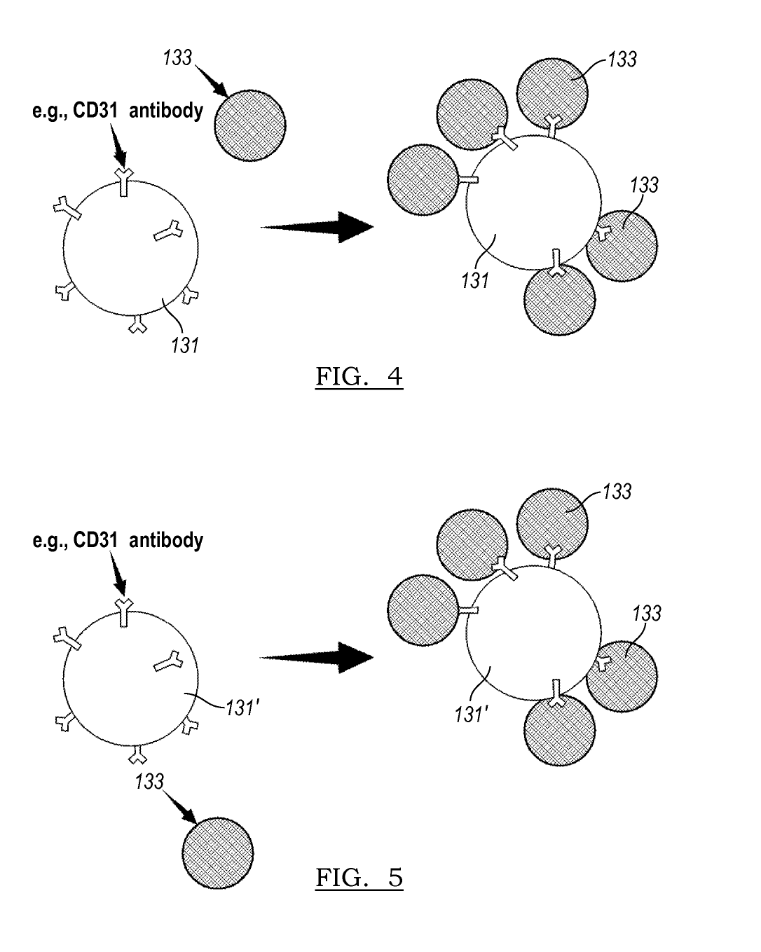

The first microfluidic particle depletion module 130 of the preferred system 100 preferably functions to remove cellular contaminants from a sample 102, but can additionally or alternatively function to remove any suitable particles not of interest from the sample 102. In particular, although the depletion module 130 is primarily described herein in terms of depleting cellular components from the sample, other variations of depletion module 130 in the preferred system 100 can additionally or alternatively deplete from the sample proteins, nucleic acids, or other particles not of interest. In a preferred embodiment, the depletion module 130 subjects the sample 102 to a force that separates a non-targeted sample component 106 of the sample 102 from a depleted sample component 104 the sample 102. The depletion module 130 preferably includes a microfluidic device that facilitates sedimentation. As shown in FIG. 3, the depletion module 130 preferably includes a long, generally straight microfluidic channel device through which the sample 102 flows, but may alternatively be a microfluidic volume of any suitable geometry. As the sample 102 flows through the device, a suspension of denser particles (e.g., cells and platelets in blood) in the sample 102 sediments over time. The microfluidic channel preferably has one inlet 132 and two outlets 134 and 136, but may alternatively have any suitable number of inlets and outlets. The inlet 132 provides the sample 102 an entrance into the channel. A first outlet 134 preferably provides the depleted sample with targeted components 104 an exit from the channel, and a second outlet 136 preferably provides non-targeted sample components 106 and other sediments an exit from the channel. Alternatively, the outlets 134 and 136 can provide an exit for non-targeted sample components 106 and depleted sample components 104, respectively (e.g., if the targeted particles of interest in the sample are denser than non-targeted particles not of interest). The microfluidic channel preferably has a height of approximately 50 μm, but may alternatively have any suitable height to allow for an efficient sedimentation. For example, sedimentation of erythrocytes, leukocytes, and platelets in a whole blood sample will complete in approximately seven minutes if the sample 102 flows through a microfluidic channel 50 μm tall. The length of the microfluidic channel is any suitable dimension and is preferably determined relative to the sample flow rate to facilitate an efficient depletion of cellular contaminants through sedimentation.

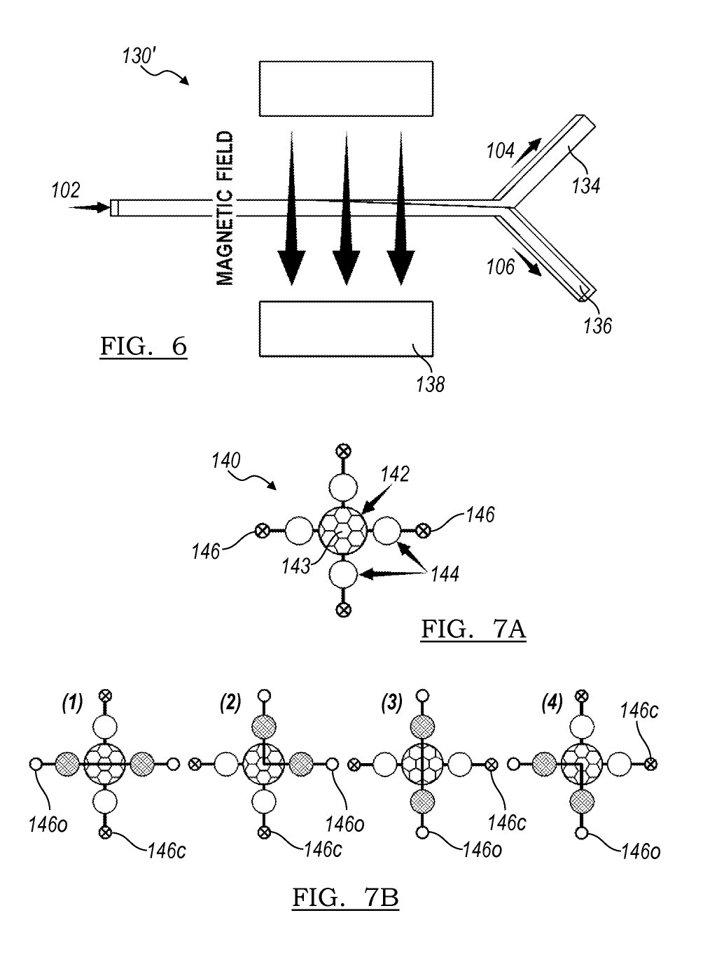

The time required for complete sedimentation depends on various factors such as sedimentation rate and channel height. The sedimentation rate of a cell or other particle to be depleted in the sample 102 can be estimated using Stokes' settling equation, and depends on factors such as density of cells and the physical characteristics of the sample. For example, an erythrocyte with a diameter of 8 μm and a density of 1.12 g/cm³ in a blood sample with a density of 1.02 g/cm³ and a viscosity of 0.01 Pa-sec has a sedimentation rate of approximately 0.6 μm/s. As shown in FIG. 4, cell sedimentation rate for lower density cells 133 such as platelets may be increased by binding a binding agent 131 such as Von Willebrand factor, fibrinogen, CD₃₁ functionalized beads, or any suitable binding agent to some or all cells to form larger combined masses that have a faster sedimentation rate.

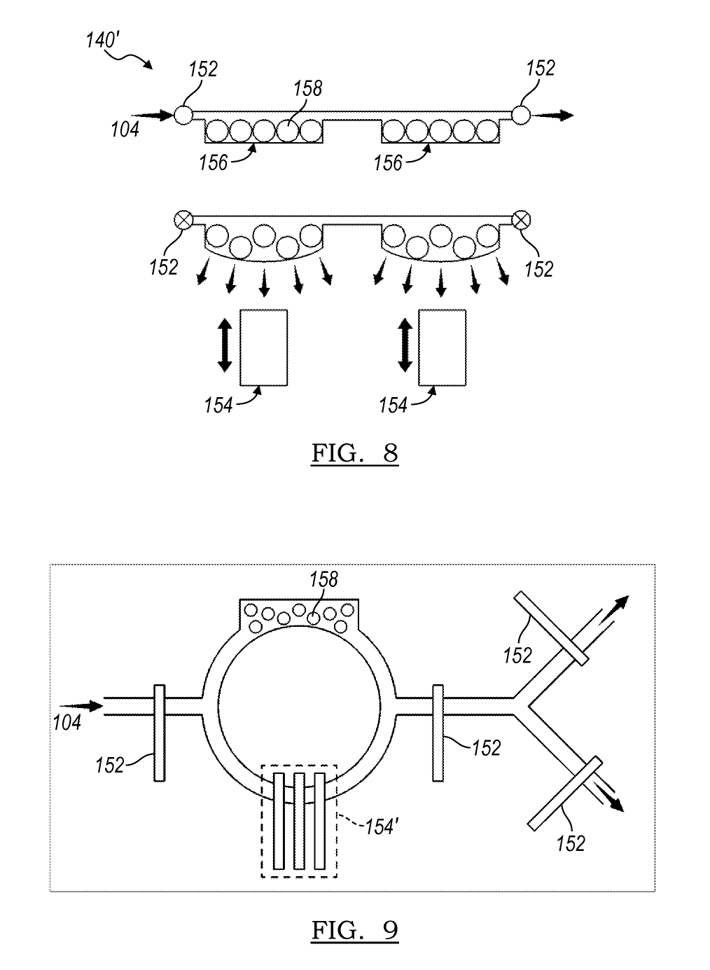

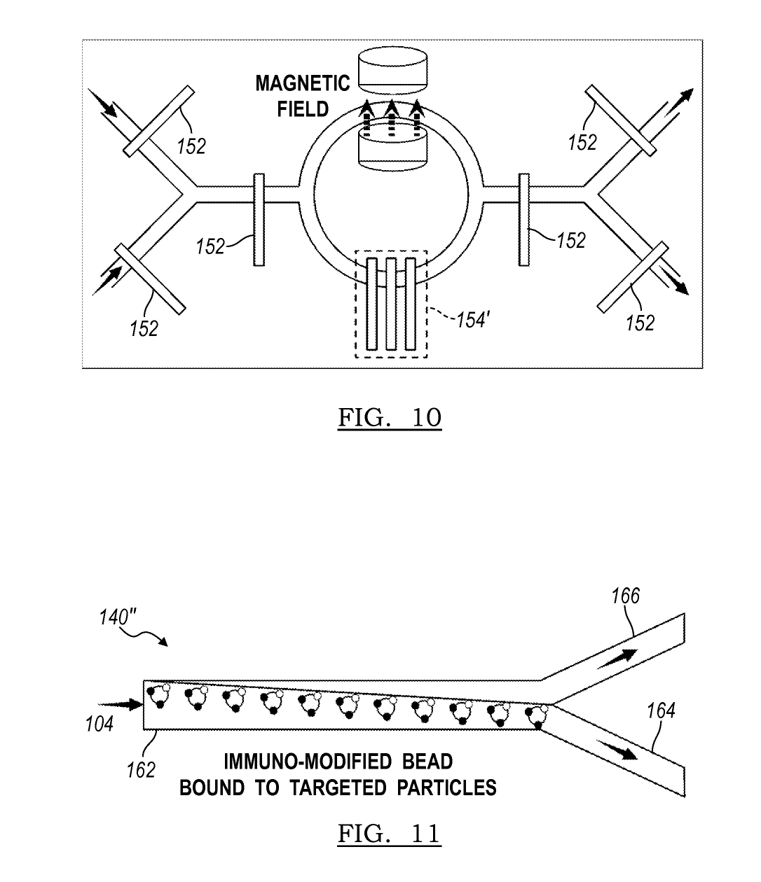

In a preferred variation, shown in FIGS. 5 and 6, the microfluidic channel of the depletion module 130′ can include a magnet 138 that applies to the sample 102 a magnetic field that additionally or alternatively encourages directed movement of cells 133 that are bound to magnetic and/or metallic microbeads 131′ or other tagging agents that are functionalized with CD₃₁, another antibody, or any suitable binding agent (FIG. 5). As shown in FIG. 6, a magnetic field applied by the magnet 138 or other magnetic means can direct magnetic or metallic microbead-bound cells or other particles downwards towards the second outlet 136, similar to the outlet for sedimented cells. Alternatively, the magnetic field can direct the magnetic or metallic microbead-bound cells upwards toward the first outlet. The direction in which the field directs the microbead-bound particles is preferably dependent on the field orientation and/or the nature of the microbead (paramagnetic, ferromagnetic, diamagnetic) and these properties can be exploited to intentionally alter the direction of flow of bound particles depending on the desired flow. The magnetic means can include a permanent magnet, an electromagnet, or any suitable one or more elements providing a magnetic field.

In a variation of the depletion module 130, the depletion module 130 alternatively and/or additionally includes a series of one or more filters through which the sample 102 flows. Each filter preferably has pores that are sized and/or shaped to selectively prevent passage of cellular contaminants as the sample 102 flows through the filter. Multiple filters placed in series may have pores of different sizes to progressively filter different sized and/or shaped cells. By trapping cellular contaminants and allowing passage of proteins and other components in the sample 102, the series of filters removes cellular contaminants from a sample 102.

The second depletion module 140 of the preferred system 100 preferably functions to separate proteins of interest from other proteins in the sample 102, but can additionally or alternatively function to separate any suitable particles of interest from other particles not of interest. In particular, although the depletion module 140 is primarily described in terms of depleting proteins not of interest in the sample 102, other variations of the depletion module 140 in the preferred system 100 can additionally or alternatively deplete from the sample nucleic acids or other particles not of interest. The depletion module 140 preferably includes a bead filled microfluidic chamber that is packed with immuno-modified beads or any suitable binding agents. The bead filled microfluidic chamber 142 preferably contains at least two openings that allow the sample to flow in and out of the microfluidic chamber, but may alternatively include any suitable number of openings. The sample 102 preferably flows over the immuno-modified beads trapped in the bead filled microfluidic chamber, and the immuno-modified beads selectively bind to proteins and capture the bound proteins in the bead filled microfluidic chamber. The immuno-modified beads are preferably specific to proteins not of interest in the sample 102, such that the immuno-modified beads deplete proteins not of interest in the sample 102, and allow the unbound proteins of interest to flow freely within the sample 102. However, the immuno-modified beads may alternatively be specific to proteins of interest to capture and isolate the proteins of interest from the sample 102. The bead filled microfluidic chamber may additionally and/or alternatively include functional groups on its surface that selectively bind and capture proteins.

In a first variation of the depletion module 140, the bead filled microfluidic chamber is preferably connected through channels to multiple peripheral sample holding microfluidic chambers 144 that hold the sample and surround the bead filled microfluidic chamber 142. As shown in FIG. 7A, the depletion module 140 preferably includes four peripheral sample holding microfluidic chambers 144 that are spaced equally around the bead filled microfluidic chamber 142, but the depletion module 140 may alternatively have any suitable number of sample holding microfluidic chambers 142 and/or chambers 142 arranged in any suitable manner. Each sample holding microfluidic chamber 144 preferably includes an opening that allows the sample to flow in and out of the sample holding chamber. The opening of each sample holding microfluidic chamber 144 preferably includes at least one actuated valve 146 that, when open, allows the sample to pass through the bead filled microfluidic chamber 142 by flowing and recirculating between sample holding microfluidic chambers 144. Alternatively, the openings of the bead filled microfluidic chamber 142 may include actuated valves 146 that, when open, allow the sample to pass through the bead filled microfluidic chamber. As the sample passes through the bead filled microfluidic chamber 142, the immuno-modified beads 143 selectively capture proteins in the sample. As shown in FIG. 7B, circulation (and in some embodiments, recirculation) of the sample between sample holding microfluidic chambers 144 can be induced in multiple directions by providing open valves 1460 and closed valves 146c of different suitable combinations of sample holding microfluidic chambers 144. Alternatively, the opening of each sample holding microfluidic chamber 144 may lack valves and allow recirculation of the sample through the bead filled microfluidic chamber 142 between sample holding microfluidic chambers 144 as a result of pressure differentials, magnetically-controlled stirrers, or any suitable recirculating mechanism. Recirculation continuously changes orientation of the proteins and their specific ligands, thereby increasing the potential for binding events to occur, and increasing the efficiency of protein isolation.

In a second variation of the depletion module 140′, the bead filled microfluidic chamber further includes actuated valves 152 that, when closed, contain the sample within the bead filled microfluidic chamber, and an actuated mixing mechanism 154 that induces mixing in the bead filled microfluidic chamber. This mixing preferably increases interaction between the proteins in the sample and immuno-modified beads 158, increases the potential for binding events to occur and increases the efficiency of protein isolation. The mixing is preferably turbulent, but can be any suitable degree of mixing. The bead filled microfluidic chamber preferably includes an outlet providing exit of the further depleted sample after a suitable amount of mixing with the beads, and can include one or more outlets providing exit of waste (e.g., with flushing of the chamber).

As shown in FIG. 8, in a first version of this variation, the actuated mixing mechanism preferably includes a flexible bottom surface 156 of the bead filled microfluidic chamber that is actuated with pneumatics to induce local convection that mixes the sample with immuno-modified beads. However, the actuated mixing mechanism 154 may be a flexible side and/or top surface of the bead filled microfluidic chamber, a shaker, and/or any suitable mixing instrument actuated by any suitable actuator mechanism. Local convection and rapid diffusion in the microscale volume of the microfluidic chamber promote high efficiency bead-based capture of proteins. Following mixing in the bead-filled microfluidic chamber, the sample exits the bead filled microfluidic chamber through an opening in the bead filled microfluidic chamber and carries any unbound proteins out of the depletion module 140.

As shown in FIG. 9, in a second version of this variation, the bead filled microfluidic chamber includes a continuous volume (e.g., in the shape of a circular or elliptical ring, or any suitable shape) throughout which the mixing mechanism 154′ induces continuous circulation of the sample over the immuno-modified beads 158, repetitively over a suitable number of cycles and/or amount of circulation time. Like the first version of this variation, the bead filled microfluidic chamber preferably includes one or more actuated valves 152 that are controlled to contain the sample within the bead filled microfluidic chamber. In this version, the mixing mechanism 154′ preferably includes a plurality of valves (e.g., three or any suitable number) that are actuated in sequence to approximate or mimic the pulsatile flow provided by a peristaltic pump. However, the mixing mechanism 154′ can include a peristaltic pump or any suitable fluid pump to drive flow of the sample around the bead filled microfluidic chamber.

As shown in FIG. 10, in a third version of this variation, the bead filled microfluidic chamber preferably includes means for applying a magnetic field (e.g., magnets external to the chamber, and/or magnetizable posts internal to the chamber) configured to capture magnetically-bound binding agents specific to particular particles, similar to that described for depletion module 130, except that the mixing occurs in a continuous circulating chamber similar to the second version of this variation or in any suitable chamber. The magnetic binding agents can be housed within the microfluidic chamber, and/or the microfluidic chamber can include a second inlet that introduces magnetic tagging agents into the microfluidic chamber.

In a fourth version of this variation, the bead filled microfluidic chamber preferably includes a movable magnet for providing a movable magnetic field (e.g., rotating external magnet) that induces flow of magnetic beads or other binding agents to interact through the received sample. In this version, the chamber is preferably a continuous circulating chamber similar to the second version of this variation, but can alternatively include any suitable chamber. The sample is preferably substantially stagnant relative to the induced movement of the magnetic beads (although the depletion module 140′ can include a rocker or other actuator to help prevent sedimentation of the sample) while the movable magnet “sweeps” the magnetic binding agents and captures particles specific to the magnetic binding agents. Alternatively, the depletion module 140′ can induce flow movement of both the sample and the magnetic binding agents.

In a first alternative of the depletion module 140″, the depletion module 140″ preferably includes a long, microfluidic channel that facilitates differential protein sorting based on density. As shown in FIG. 11, the microfluidic channel of the depletion module 140″ is similar to the long, microfluidic channel of the depletion module 130 except that the depletion module 140″ may sort proteins that are buoyant in the sample, as an alternative and/or in addition to sorting proteins that sediment in the sample. The depletion module 140″ preferably includes a mixing chamber at the entrance of the microfluidic chamber to induce turbulent mixing of proteins and beads functionalized with antibodies specific to selected proteins, facilitating binding events between the proteins (or nucleic acids or other particles) and beads to occur. Alternatively, these binding events may occur external to the depletion module 140 prior to the sample entering the microfluidic channel, such as in tagging conduit 120. Depending on the specific application, the beads may be made of a high density material such as silica or glass to promote sedimentation of selected bound proteins, but may alternatively and/or additionally be made of light polymers or hollow polymer shells to promote buoyancy of selected bound proteins. As the sample flows through the microfluidic channel, bound proteins in the sample sediment to the bottom of the channel and/or rise to the top of the channel over time. The microfluidic channel preferably has one inlet 162 and two outlets 164 and 166, but may alternatively have any suitable number of inlets and outlets. The inlet 162 preferably provides the sample 102 an entrance into the channel. As shown in FIG. 11, a first outlet 164 preferably provides bound proteins an exit from the channel, and a second outlet 166 preferably provides the unbound proteins in the sample an exit from the channel. Alternatively, the microfluidic channel may have any suitable number of inlets and/or outlets. As an example, the microfluidic channel may have three outlets: a first outlet that provides sediment an exit from the channel, a second outlet that provides buoyant proteins an exit from the channel, and a third outlet to provide the rest of the sample with unbound proteins an exit from the channel.

Similar to the depletion module 130, the microfluidic channel of the depletion module 140 may be subjected to a magnetic field that additionally and/or alternatively encourages directed movement of proteins not of interest (such as HAS and IgG) that are bound to magnetic and/or metallic microbeads or other tagging agents that are functionalized with CD₃₁, another antibody, or any suitable binding agent. In particular, a magnetic field may direct magnetic or metallic microbead-bound proteins of interest downwards towards the second outlet, similar to the outlet for sedimented proteins, or the magnetic field may direct the magnetic or metallic microbead-bound proteins upwards toward the first outlet.

In a second alternative of the depletion module 140, the depletion module 140 alternatively and/or additionally includes a series of one or more filters 172 through which the sample flows. As shown in FIG. 12, the series of filters 172 of the depletion module 140 is similar to that of the depletion module 130, except that each filter preferably has pores that are sized and/or shaped to selectively prevent passage of proteins and other molecules as the sample flows through the filter. The sample preferably flows through filters with progressively smaller pores, to deplete the sample of progressively smaller proteins and smaller peptides, but may flow through the filters in any suitable order. The filters are additionally and/or alternatively constructed from selected materials and/or in selected processes to further filter the sample based on lipid solubility or ionic charge, such as ion exchange membranes similar to diffusion dialysis membranes known by those of ordinary skill in the art.

Further variations and alternatives of the depletion module 140 include every combination and permutation of the described variations and alternatives of the depletion module 140 used in series, and may be tailored depending on the specific application.

An alternative embodiment of the system 100 further includes a nucleic acid isolation and analysis module and/or an intracellular protein isolation and analysis module that operates on and analyzes cellular samples. Cellular samples may be the result of cell depletion in the depletion module 130, or another suitable cell isolation system and/or process, preferably similar to that described in U.S. Patent Application 2011/0020459 entitled “Microfluidic method and system for isolating particles from biological fluid”, which is incorporated in its entirety by this reference. The nucleic acid isolation and analysis module functions to extract DNA and/or RNA from selected cells for analysis. The intracellular protein isolation and analysis module functions to extract intracellular proteins from selected cells and to perform proteomic analysis on the extracted intracellular proteins. As a specific example, circulating tumor cells (CTCs) that have been depleted from the sample in the depletion module 130 may have their gene expression analyzed for tumor grading. Thus, one could use the nucleic acid isolation and analysis module to extract and analyze DNA from CTCs to determine chemotherapy targets, and to use the cell protein isolation and analysis module to isolate proteins from within the CTCs that may be markers that are more specific than conventionally used tumor antigen.

Variations of the system 100 include every combination and permutation of the described variations of the depletion modules 130 and 140. The use of each module for a particular application depends on the type of sample and the kind of output desired. In further variations of the microfluidic system 100, the sequence in which the various modules are used may also be tailored towards the specific application of the system 100. The various microfluidic devices are preferably manufactured with soft lithography techniques. Soft lithography processes are known and used in the art of manufacturing microscale devices, and the implementation of soft lithography processes in the microfluidic device would be readily understood by a person of ordinary skill in the art. However, the microfluidic devices can additionally or alternatively be manufactured in any suitable manner.

Method for Automated Processing of Particles from Biological Fluid

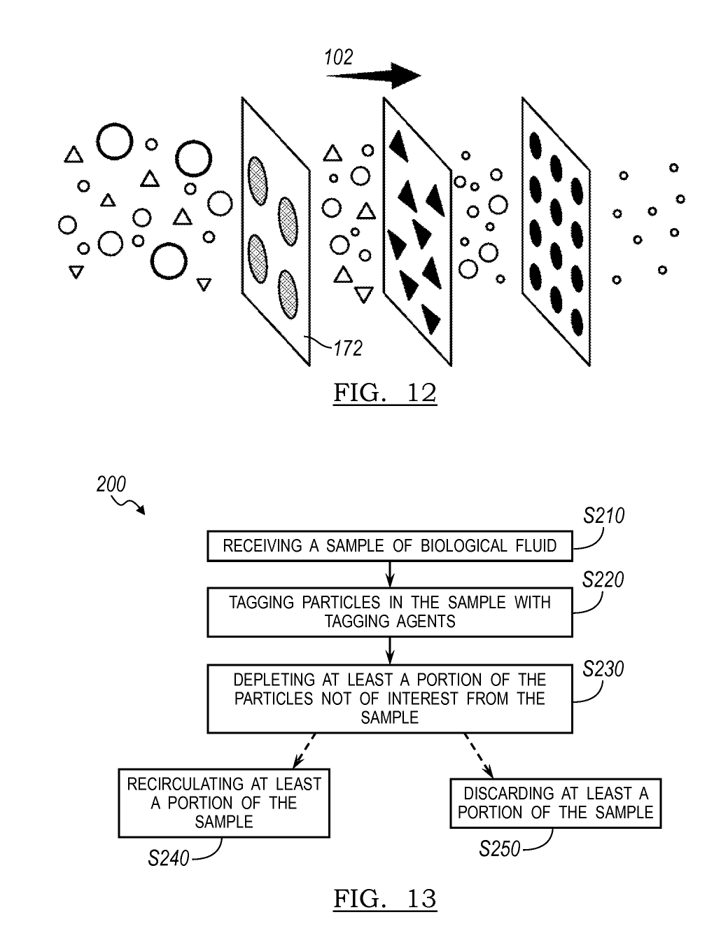

As shown in FIG. 13, the method 200 includes: in block S210, receiving a sample of biological fluid; and in block S230, depleting at least a portion of the particles not of interest from the sample. The method 200 preferably facilitates isolation of diagnostically relevant particles (proteins, peptides, nucleic acids, and cells) that are present in blood or other relevant fluid sample types, including but not limited to urine, saliva, and cerebrospinal fluid (CSF), by sorting particles with the use of specific functionalized beads. As an example, the method 200 may isolate tumor antigens like PSA, CA 19-9, CA 125, CEA, and AFP that are present in blood. In alternative embodiments, the method 200 may be used to isolate nucleic acids using beads selectively bound to particular nucleic acids, including but not limited to DNA, RNA, or microRNA, such as for isolating DNA from specific cell types or isolating RNA for cell type-specific gene expression analysis. The preferred method 200 preferably depletes the sample, in an automated manner, of particles not of interest in order to isolate or produce a depleted sample substantially including only particles of interest. In a preferred embodiment, the particles not of interest can be abundant within a sample and overwhelm less populous particles of interest. For example, the method 200 can be configured to deplete the received sample of cellular contaminants, abundant nucleic acids such as globin messenger RNA transcripts, and abundant proteins such as Albumin, IgG, IgA, IgM, Fibrinogen, Haptoglobin, Alpha 1 antitrypsin, Apo A I, Apo A II, and A2 Macroglobulin.

In particular, the method 200 preferably facilitates isolation of diagnostically relevant particles such as proteins, peptides, and nucleic acids that are present in blood or other relevant fluid sample types (e.g., urine, saliva, cerebrospinal fluid (CSF), serum, plasma, tears, cell lysates, and cell culture media) by sorting particular particles with particular expression characteristics with the use of agents selectively bound to particular particles through antibodies or other specific recognition agents (e.g., diabodies, fab fragments, aptamers, and oligonucleotides). In alternative embodiments, the method 200 can be used to isolate nucleic acids using agents selectively bound to particular nucleic acids, including but not limited to DNA, RNA, or microRNA, such as for isolating DNA from specific cell types or isolating RNA for cell type-specific gene expression analysis. However, the method 200 can additionally or alternatively be used to isolate any suitable particles of interest by depletion of any suitable particles not of interest in the sample.

The preferred method 200 is preferably used at the point-of-care for clinical purposes including prognosis, diagnosis, and/or patient monitoring, but can additionally or alternatively be performed in a research and/or laboratory environment, such as to enable clinician-scientists to process samples at the point-of-care in clinical trials and research. In some embodiments in which at least some of the sample 102 is returned to the patient for recirculation in the body of the patient, the method 200 can selectively isolate and remove specific proteins and/or other particles from the sample 102 of biological fluid, while returning the remaining processed fluid back to the patient. Furthermore, in some embodiments of the method 200 the method 200 can include adding a therapeutic agent to the returning fluid to help treat the patient by, for example, controlling administration of therapeutic agents on the basis of detected levels of particles present in the biological fluid of the patient. However, the method 200 can additionally or alternatively include discarding at least a portion of the sample.

Block S210 recites receiving a sample of biological fluid. Block S210 preferably functions to receive a sample of biological fluid for analytical purposes. The sample may be blood, cerebrospinal fluid, or urine, or any suitable bodily fluid. Receiving a sample S210 preferably includes receiving fluid from a catheter, needle, or any suitable cannula at the point-of-care of the patient, such as at bedside during in-patient care or the outpatient setting in patients with in-dwelling catheters or other cannulas. For example, a blood sample may be obtained through an arterial line, an intravenous line, a peripherally inserted central catheter, or a central line. As another example, a cerebrospinal fluid sample may be obtained through an external ventricular drain or a lumbar drain. As another example, a urine sample may be obtained through a Foley catheter or a suprapubic catheter. The process of sample collection from catheter or cannula to the microfluidic device can be further assisted by use of vacuum tubing and/or roller mechanisms that facilitate movement of the fluid through the catheter system rapidly to the microfluidic device. These and other fluid extraction methods are well known in the art, and any suitable method of obtaining bodily fluid may be performed. Alternatively, receiving a sample S210 can include receiving the sample from any suitable source, such as in research or laboratory applications. The sample is preferably heterogeneous in that it preferably includes particles of multiple sample particle types. For instance, a blood sample typically includes more populous cell types like erythrocytes and leukocytes, and may include rarer cell types like CTCs. Each sample particle type may further be classified as a targeted particle that is of interest or an untargeted particle that is not of interest, and its classification preferably depends on the specific application of the method 200.

Receiving a sample in block S210 preferably further includes obtaining a uniform distribution of particles in the sample. Obtaining a uniform distribution may include perturbing with a rocker mechanism that continuously, gently agitates the sample, with a rotating mechanism that continuously, gently turns the sample against gravity like a cement truck, or any suitable mechanism that shifts the sample enough to prevent sedimentation of cells in the sample and helps ensure a uniform particle distribution in the sample.

In some embodiments, the method 200 can include block S220, which recites tagging particles in the sample with tagging agents. The tagging agents preferably selectively bind to particles that enable labeling or distinguishing between different particle types. Block S220 is preferably similar to that described in U.S. Patent Application 2011/0020459 entitled “Microfluidic method and system for isolating particles from biological fluid”, which is incorporated in its entirety by this reference. However, the method 200 can include any suitable process for tagging any portion of particles in the sample.

Block S230 recites depleting at least a portion of the particles not of interest from the sample. Block S230 preferably functions to separate from the sample at least a portion of the particles not of interest from the sample. In a first preferred embodiment, block S230 includes subjecting the sample to a force that separates at least a portion of the particles not of interest from the sample. In a first variation, Block S230 preferably includes facilitating sedimentation of particles not of interest (e.g., cellular contaminants) in the sample. Facilitating sedimentation of particles not of interest preferably includes passing the sample through a long, generally straight microfluidic channel device, but may alternatively include passing the sample through any suitable microfluidic volume that allows sedimentation of particles in the sample as the sample passes through the microfluidic volume. In one variation, facilitating sedimentation of particles not of interest may further include increasing sedimentation rate by binding Von Willebrand factor, fibrinogen, CD₃₁ functionalized beads, or any suitable binding agent to some or all particles not of interest to form larger combined masses that have a faster sedimentation rate. Block S230 may additionally and/or alternatively include tagging particles with magnetic and/or metallic microbeads or other tagging agents and applying a magnetic field to the microfluidic channel device to selectively direct movement of the tagged particles in a particular direction to separate the particles not of interest in the sample from the rest of the sample.

In a second preferred embodiment, Block S230 includes passing the sample through a chamber filled with binding agents specific to selected proteins or other particles and inducing sample recirculation in the chamber. While passing the sample through a chamber filled with binding agents, the binding agents preferably bind to proteins or other particles not of interest in the sample and allow particles of interest to remain unbound and free to flow with the sample. Alternatively, the binding agents may bind to particles of interest in the sample to capture and isolate particles of interest in the sample. The binding agents are preferably immuno-modified beads, but may alternatively be any suitable binding agent. Inducing sample recirculation in the chamber increases the occurrence of binding events between the binding agents and selected particles in the chamber. In one preferred embodiment, the sample recirculation is preferably performed by facilitating repeated flow sample into and out of the chamber. In another preferred embodiment, the sample recirculation is preferably additionally and/or alternatively be performed by inducing mixing within a microfluidic chamber sealable with actuated valves or any suitable mechanism. For example, the sample can be circulated through a continuous volume over a constrained volume of binding agents to capture specific particles, or binding agents can be circulated (e.g., magnetic binding agents controlled by a magnet) over a constrained volume of the sample. In another example, block S230 includes inducing circulating flow of both the sample and the volume of binding agents.

In a third preferred embodiment, Block S230 alternatively and/or additionally includes filtering particles in the sample. Filtering particles in the sample is preferably performed by passing the sample through a series of filters, each of which includes pores that are sized and/or shaped to selectively prevent passage of cells, proteins and/pr other particles not of interest as the sample passes through the filter. The sample preferably flows through filters with progressively smaller pores, to deplete the sample of progressively smaller particles, but may flow through the filters in any suitable order. The filters are additionally and/or alternatively constructed from selected materials and/or in selected processes to further filter the sample based on lipid solubility or ionic charge, such as ion exchange membranes similar to diffusion dialysis membranes known by those of ordinary skill in the art.

As shown in FIG. 11, in some embodiments of the method 200, the method 200 further includes recirculating at least a portion of the sample in block S240 to the body of the patient or other original source of the biological fluid sample, such as through a catheter setup similar to dialysis machines, particularly embodiments in which the sample is blood or cerebrospinal fluid. In one preferred variation, recirculating includes modifying the sample and returning at least a portion of the sample to the body of the patient. Modifying the sample may include: removing selected particles or substances from the sample, adding selected particles or substances to the sample, and/or adding a therapeutic agent such as a therapeutic drug or nutrients from one or more reservoirs. As an example, the therapeutic agent may be administered based on the results of enumerating groups of particles or other analysis of the separated groups of particles (e.g. percentage of cells with intracellular particles of interest), additional treatment recommendations, and/or any suitable basis for therapy. However, in some embodiments of the method 200, the method 200 can additionally or alternatively include discarding at least a portion of the sample in block 250.

Variations of the preferred method 200 include every combination and permutation of any variations of receiving a sample in block S210, tagging particles in the sample with tagging agents in block S220, depleting at least a portion of the particles not of interest from the sample in block S230, and recirculating at least a portion of the sample in block S250. The performance of each process for a particular application depends on the type of sample and the kind of output desired.

As a person skilled in the art will recognize from the previous detailed description and from the figures and claims, modifications and changes can be made to the preferred embodiments of the invention without departing from the scope of this invention defined in the following claims.

We claim:

1. A microfluidic system for automatically depleting particles not of interest from a sample of biological fluid comprising particles of interest and particles not of interest, wherein the particles of interest include at least one of proteins and nucleic acids, the system comprising:
a sampling module, configured to fluidically couple to a cannula coupled to the patient and to receive the sample of biological fluid from the patient at a point-of-care of the patient;
at least one microfluidic particle depletion module fluidically coupled in series to the sampling module to receive the sample, wherein each of the microfluidic particle depletion modules comprises a microfluidic chamber configured to separate at least a portion of the particles not of interest from the sample, thereby isolating at least a portion of the particles of interest.

2. The microfluidic system of claim 1, wherein the microfluidic chamber comprises a particle depletion module inlet for receiving the sample, a first particle depletion module outlet for providing exit of substantially only the particles not of interest of the sample, and a second particle depletion module outlet for providing exit of substantially only the particles of interest of the sample.

3. The microfluidic system of claim 2, wherein the microfluidic chamber has a length defined between the particle depletion module inlet and the second particle depletion module outlet and configured to enable gravitational sedimentation of at least a portion of the particles not of interest relative to the particles of interest of the sample.

4. The microfluidic system of claim 2, further comprising a microfluidic tagging conduit comprising a first tagging conduit inlet for receiving the sample, a second tagging conduit inlet for receiving a solution of tagging agents that selectively bind to the particles not of interest, and a textured surface configured to induce mixing of the sample and the solution of tagging agents.

5. The microfluidic system of claim 4, wherein the tagging agents are magnetic tagging agents, and wherein at least one of the particle depletion modules comprises a means for applying a magnetic force on the sample.

6. The microfluidic system of claim 4, wherein the tagging agents are configured to selectively bind to particles not of interest depending on at least one of size, shape, and physiochemical properties.

7. The microfluidic system of claim 2, wherein the particle depletion module is configured to separate from the sample particles not of interest comprising at least one particle selected from the group consisting of: cells, proteins, and nucleic acids.

8. The microfludic system of claim 1, wherein the microfluidic protein depletion module comprises a plurality of binding agents disposed within the microfluidic chamber, wherein the binding agents are configured to selectively bind to the particles not of interest.

9. The microfluidic system of claim 9, wherein the binding agents selectively bind to abundant proteins comprising at least one protein selected from the group consisting of: albumin, IgG, IgA, IgM, fibrinogen, haptoglobin, alpha 1 antitrypsin, Apo A I, Apo A II, and A2 macroglobulin.

10. The microfluidic system of claim 8, wherein the binding agents comprise specific recognition agents selected from the group consisting of: proteins, enzymes, ligands, receptors, peptides, antibodies, diabodies, fab fragments, aptamers, oligonucleotides, synthetic substance, peptibodies, nucleic acids, and oligonucleotides.

11. The microfluidic system of claim 8, wherein the binding agents selectively bind to abundant globin messenger RNA transcripts.

12. The microfluidic system of claim 1, where in the particle depletion module comprises a plurality of peripheral microfluidic chambers distributed around and fluidically coupled to the first microfluidic chamber.

13. The microfluidic system of claim 12, wherein the particle depletion module is configured to induce circulation of the sample between the peripheral microfluidic chambers and through the first microfluidic chamber across the binding agents.

14. The microfluidic system of claim 13, wherein the particle depletion module comprises valves that control flow between the plurality of peripheral microfluidic chambers.

15. The microfluidic system of claim 1, wherein the microfluidic chamber of the particle depletion module is substantially sealable and the protein depletion module comprises a mixing mechanism configured to induce mixing within the sealed microfluidic chamber.

14. The microfluidic system of claim 13, wherein the microfluidic chamber of the particle depletion module comprises a deflectable surface.

15. A microfluidic system for automatically depleting particles not of interest from a sample of biological fluid comprising particles of interest and particles not of interest, wherein the particles of interest include at least one of proteins and nucleic acids, the system comprising:
a sampling module configured to receive the sample of biological fluid;
a first microfluidic particle depletion module, fluidically coupled to the sampling module to receive the sample and configured to subject the received sample to a force that separates at least a portion of the particles not of interest from the sample, thereby providing a depleted sample;
a second microfluidic particle depletion module, fluidically coupled to the first microfluidic particle depletion module to receive the depleted sample, comprising a microfluidic chamber and binding agents disposed within the microfluidic chamber, wherein the binding agents are configured to selectively bind to at least one of proteins of interest and proteins not of interest.

16. The microfluidic system of claim 15, wherein the sampling module is configured to fluidically couple to a cannula coupled to the patient and to receive the sample of biological fluid from the patient at a point-of-care of the patient.

17. The microfluidic system of claim 15, wherein the sampling module is configured to receive a fluid from a fluid cartridge.

18. The microfluidic system of claim 15, wherein at least one of the first and second microfluidic particle depletion modules is configured to separate from the sample particles not of interest comprising at least one particle selected from the group consisting of: cells, proteins, and nucleic acids.

19. The microfluidic system of claim 18, wherein at least one of the first and second microfluidic particle depletion modules is configured to separate from the sample particles not of interest comprising at least one protein selected from the group consisting of: albumin, IgG, IgA, IgM, fibrinogen, haptoglobin, alpha 1 antitrypsin, Apo A I, Apo A II, and A2 macroglobulin.

20. The microfluidic system of claim 18, wherein at least one of the first and second microfluidic particle depletion modules is configured to separate from the sample nucleic acids not of interest comprising abundant globin messenger RNA transcripts.

21. A method for automatically depleting particles not of interest from a sample of biological fluid having a target component comprising particles of interest and particles not of interest, wherein the particles of interest include at least one of proteins and nucleic acids, the method comprising:
receiving the sample of biological fluid;
subjecting the sample to a force that separates at least a portion of the particles not of interest from the sample, thereby isolating at least a portion of the target component;
passing the isolated target component of the sample into a first microfluidic chamber;
circulating the isolated target component of the sample within the first microfluidic chamber; and
selectively capturing the particles not of interest with binding agents disposed within the first microfluidic chamber.

22. The method of claim 21, wherein receiving the sample of biological fluid comprises receiving the sample directly from a cannula coupled to the patient at a point-of-care of the patient.

23. The method of claim 21, wherein receiving the sample of biological fluid comprises receiving the sample from a fluid cartridge.

24. The method of claim 21, wherein receiving the sample of biological fluid comprises receiving a sample of a substance selected from the group consisting of whole blood, serum, plasma, saliva, cerebrospinal fluid, urine, tears, cell lysates, and cell culture media.

25. The method of claim 21, wherein subjecting the sample to a force includes separating from the sample particles not of interest comprising at least one selected from the group consisting of: cells, proteins, and nucleic acids.

26. The method of claim 25, wherein selectively capturing the particles not of interest comprises capturing abundant proteins comprising at least one protein selected from the group consisting of: albumin, IgG, IgA, IgM, fibrinogen, haptoglobin, alpha 1 antitrypsin, Apo A I, Apo A II, and A2 macroglobulin.

27. The method of claim 25, wherein selectively capturing the particles not of interest comprises capturing nucleic acids not of interest comprising abundant globin messenger RNA transcripts.

28. The method of claim 21, wherein subjecting the sample to a force comprises facilitating gravitational sedimentation of particles not of the interest relative to at least a portion of the particles of interest of the sample.

29. The method of claim 21, further comprising selectively binding magnetic tagging agents to particles not of interest, and wherein subjecting the sample to a force comprises applying a magnetic force on the sample.

30. method of claim 21, wherein passing the protein component of the sample into a first microfluidic chamber comprises circulating the protein component of the sample between a plurality of peripheral microfluidic chambers distributed around and fluidically coupled to the first microfluidic chamber.
